(19) United States
(12) Patent Application Publication
(10) Pub. No.: US 2026/0267045 A1
(43) Pub. Date: Sep. 10, 2026

(54) VIRTUAL IMAGE DISPLAY APPARATUS AND OPTICAL UNIT

(71) Applicant: SEIKO EPSON CORPORATION, Tokyo (JP)

(72) Inventor: Atsushi SAITO, CHINO-SHI (JP)

(73) Assignee: SEIKO EPSON CORPORATION, Tokyo (JP)

(21) Appl. No.: 19/555,938

(22) Filed: Mar. 4, 2026

(30) Foreign Application Priority Data
Mar. 5, 2025 (JP) 2025-034367

(51) Int. Cl. G02B 5/18

(52) U.S. Cl. CPC G02B 5/1866

(57) ABSTRACT

A virtual image display apparatus or an optical unit includes a display unit configured to output circularly polarized video light and transmit outside light; and a polarizing diffractive lens having a diffracting region configured to collect the video light output from the display unit and a non-diffracting region configured to transmit the outside light passing through the display unit.

The present application is based on, and claims priority from JP Application Serial Number 2025-034367, filed Mar. 5, 2025, the disclosure of which is hereby incorporated by reference herein in its entirety.

### BACKGROUND

### 1. Technical Field

The present disclosure relates to a virtual image display apparatus and an optical unit that allow observation of a virtual image, and particularly to a virtual image display apparatus and the like using a polarizing diffractive lens.

### 2. Related Art

As a polarization conversion system, a system including a geometric phase element and a retarder element is known (see JP-T-2016-519327). The geometric phase element has optical anisotropy having a local optical axis direction that changes nonlinearly in at least one dimension along the surface thereof. The retarder element is disposed to receive light output from the geometric phase element.

JP-T-2016-519327 is an example of the related art.

The geometric phase element in the polarization conversion system described above has the function of causing right-handed circularly polarized light to converge, and the function of causing left-handed circularly polarized light to diverge. Therefore, even when the system described in JP-T-2016-519327 is simply used in a virtual image display apparatus, it is difficult to achieve both video observation and outside light observation. To achieve a see-through virtual image display apparatus, it is necessary to dispose the geometric phase element at a position away from the see-through region, so that there is a problem of an increase in the size of the optical system.

### SUMMARY

A virtual image display apparatus and an optical unit according to an aspect of the present disclosure each include: a display unit configured to output circularly polarized video light and transmit outside light; and a polarizing diffractive lens having a diffracting region configured to collect the video light output from the display unit and a non-diffracting region configured to transmit the outside light passing through the display unit.

### BRIEF DESCRIPTION OF THE DRAWINGS

FIG. 1 is an exterior front view illustrating a state in which virtual image display apparatuses according to a first embodiment are mounted.

FIG. 2 is a conceptual perspective view illustrating the structure of a virtual image display apparatus.

FIG. 3 is a conceptual side cross-sectional view illustrating the configuration of a display optical system.

FIG. 4 is a conceptual view illustrating beams that form outside light reaching an eye.

FIG. 5 is a rear view illustrating an image display panel.

FIG. 6 is a rear view illustrating a polarizing element.

FIG. 7 is a rear view illustrating a polarizing diffractive lens.

FIG. 8 illustrates the function of the polarizing diffractive lens.

FIG. 9 illustrates the state of light in the display optical system.

FIG. 10 is a rear view illustrating the polarizing diffractive lens of a virtual image display apparatus according to a second embodiment.

FIG. 11 illustrates a variation of the polarizing diffractive lens shown in FIG. 10.

FIG. 12 is a rear view illustrating a polarizing element of a virtual image display apparatus according to a third embodiment.

FIG. 13 is a conceptual perspective view illustrating the structure of a virtual image display apparatus according to a fourth embodiment.

FIG. 14 is a conceptual side cross-sectional view illustrating the configuration of a display optical system in FIG. 13.

FIG. 15 illustrates the state of light in the display optical system shown in FIG. 13.

FIG. 16 is a chart illustrating the operation of the virtual image display apparatus in FIG. 13.

FIG. 17 is a conceptual side cross-sectional view illustrating a variation of the display unit in FIG. 13.

### DESCRIPTION OF EMBODIMENTS

### First embodiment

A virtual image display apparatus according to a first embodiment of the present disclosure will be described below with reference to the drawings.

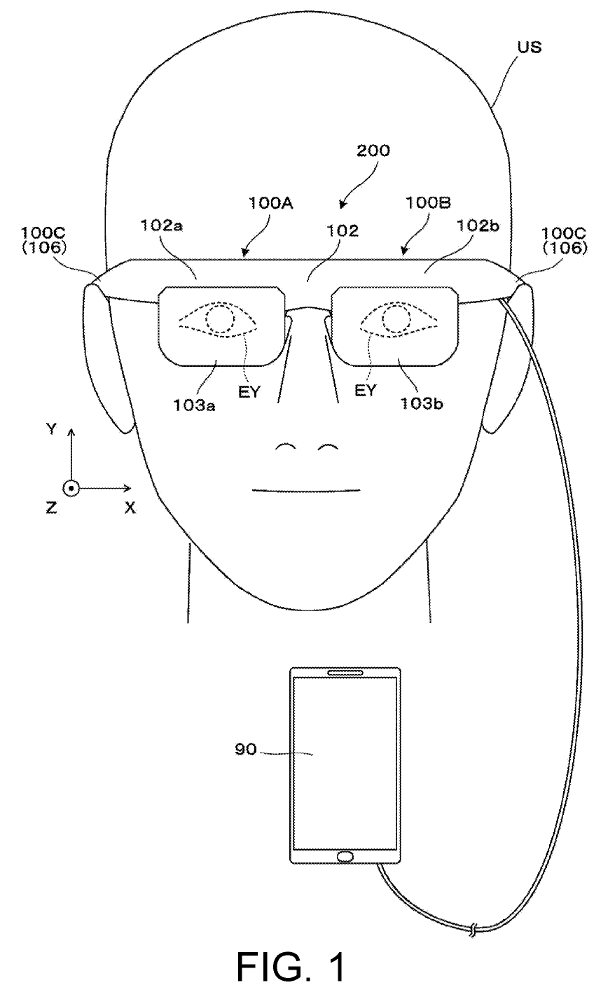

FIG. 1 is a front view illustrating a state in which a head mounted display 200 is mounted. The head mounted display (hereinafter also referred to as HMD) 200 allows an observer or a wearer US, who wears the HMD 200, to recognize a video in the form of virtual images. In FIG. 1 and other figures, X, Y, and Z form an orthogonal coordinate system, a +X direction corresponds to a lateral direction in which two eyes EY of the observer or wearer US, who wears the HMD 200, are arranged, a +Y direction corresponds to an upward direction perpendicular to the lateral direction with respect to the wearer US, in which the two eyes EY are arranged, and a +Z direction corresponds to a forward or frontward direction with respect to the wearer US. The ±Y directions are parallel to the vertical axis or the vertical direction.

The HMD 200 includes a first virtual image display apparatus 100A for the right eye, a second virtual image display apparatus 100B for the left eye, a pair of temples 100C, which support the virtual image display apparatuses 100A and 100B, and a user terminal 90, which is an information terminal. The first virtual image display apparatus 100A is configured with a first display driver 102a disposed on the upper side, and a first display optical system 103a, which covers the front of the right eye. The second virtual image display apparatus 100B is configured with a second display driver 102b disposed on the upper side, and a second display optical system 103b, which covers the front of the left eye. The HMD 200, which is the combination of the first virtual image display apparatus 100A and the second virtual image display apparatus 100B, is also a virtual image display apparatus in a broad sense. The pair of temples 100C are mounting members or supports 106 mounted on the head of the wearer US, and support the upper ends of the pair of display optical systems 103a and 103b via the display drivers 102a and 102b integrated with each other in appearance. The combination of the pair of display drivers 102a and 102b is called a drive apparatus 102.

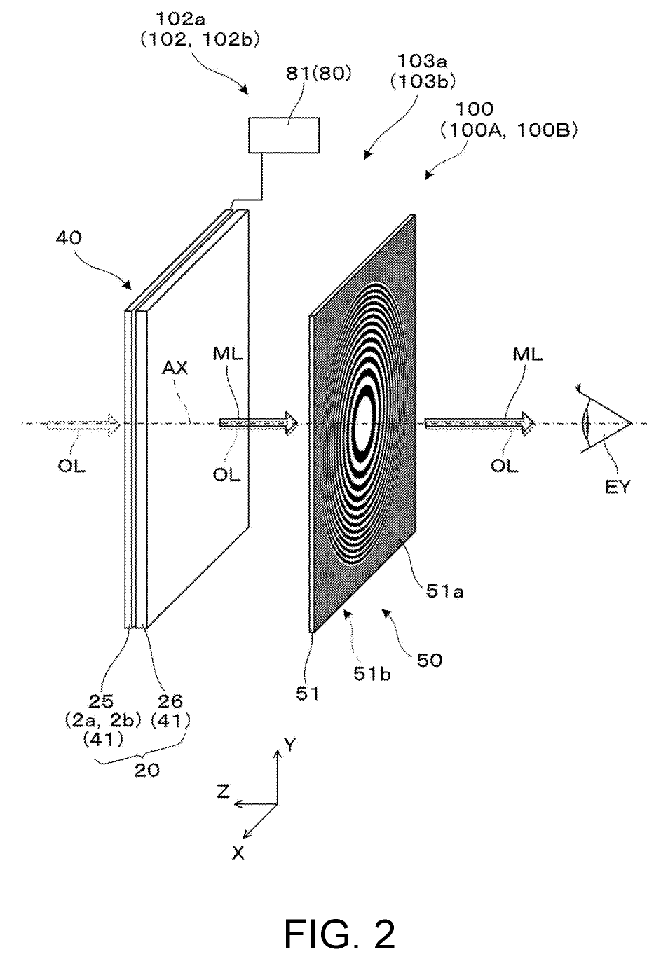

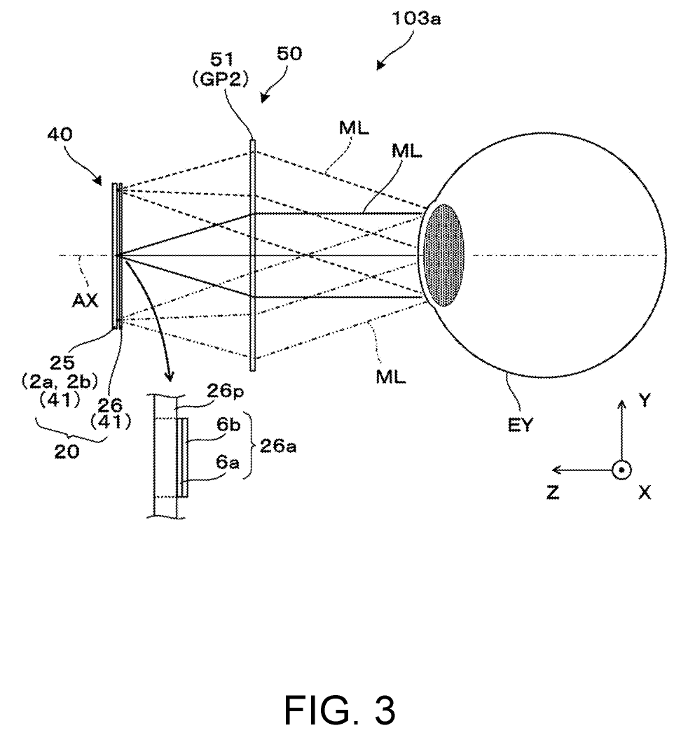

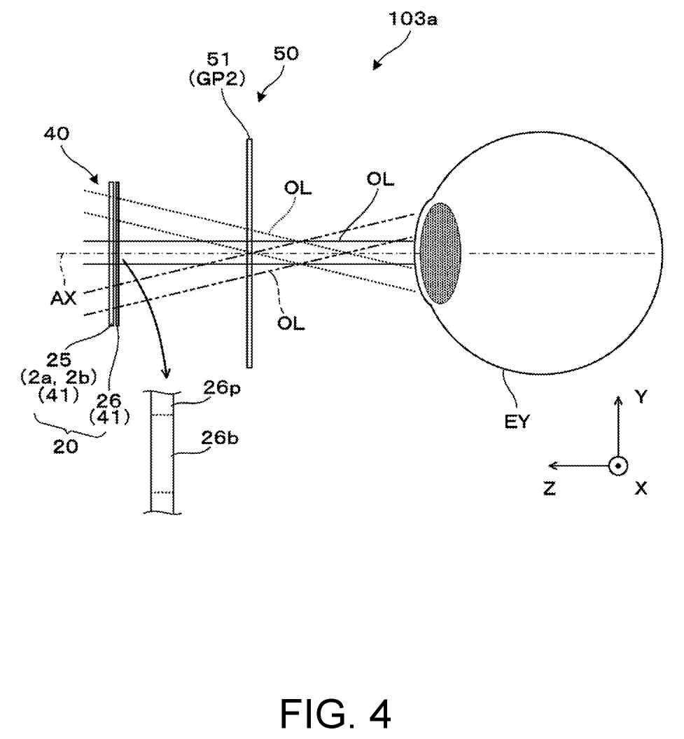

FIG. 2 is a conceptual perspective view illustrating the structure of the first display optical system 103a of the first virtual image display apparatus 100A. FIG. 3 is a conceptual side cross-sectional view illustrating the configuration of the first display optical system 103a. FIG. 3 is also a conceptual view illustrating beams that form video light ML traveling to one of the eyes EY in the first display optical system 103a. FIG. 4 is a conceptual view illustrating beams that form outside light OL traveling to the eye EY in the first display optical system 103a.

The first display optical system 103a includes a plate-shaped display unit 40, which forms two-dimensional images and outputs the video light ML corresponding to the two-dimensional images, and an imaging system 50, which functions as a lens affecting the video light ML output from the display unit 40 and forms virtual images.

The display unit 40 outputs the video light ML, which is circularly polarized light, and transmits the outside light OL. The display unit 40 includes a composite display member 20, which forms and outputs the video light ML. The composite display member 20 is a plate-shaped member extending along an XY plane perpendicular to an optical axis AX, and includes an image display panel 25 as a display member 2b and a polarizing element 26 arranged sequentially from the side facing the display unit 40. The composite display member 20 has a structure in which the image display panel 25 and the polarizing element 26 are layered on each other and integrated into a single unit by a frame that is not shown. In the present embodiment, the image display panel 25 and the polarizing element 26 function as a light separating member 41, which separates the video light ML and the outside light OL from each other as different optical components. As will be described later in detail, the different optical components mean that the video light ML is circularly polarized light collected by the imaging system 50 and the outside light OL is not circularly polarized light. The outside light OL is, for example, unpolarized light or linearly polarized light.

The display unit 40 operates when driven by a drive circuit 81 of a controller 80 incorporated in the first display driver 102a or the drive apparatus 102. The composite display member 20 of the display unit 40 is disposed close to the eye EY with the imaging system 50 interposed therebetween, and enables observation of virtual images formed by the video light ML and see-through viewing of the outside space. In the first display optical system 103a, the distance between the eye EY and the imaging system 50 in the direction of the optical axis AX is, for example, in a range between about 10 mm and 20 mm. The distance between the image display panel 25 of the display unit 40 and the imaging system 50 in the direction of the optical axis AX is in a range, for example, between about 5 mm and 25 mm.

The image display panel 25 is a self-luminous image light generator and outputs the video light ML, which is the combination of red light, green light, and blue light. The image display panel 25 is an imager 2a, which forms still images or motion images on a two-dimensional display surface parallel to the XY plane. The image display panel 25 is driven by the drive circuit 81 to perform the display operation.

The image display panel 25 is, for example, a transmissive organic light emitting diode (OLED) display, and may instead be a micro light emitting diode (μLED) display made of an inorganic material or another light-transmissive self-luminous display device. Note that the image display panel 25 may be replaced with a configuration in which a projection optical system is used to project the video light ML onto a transparent screen.

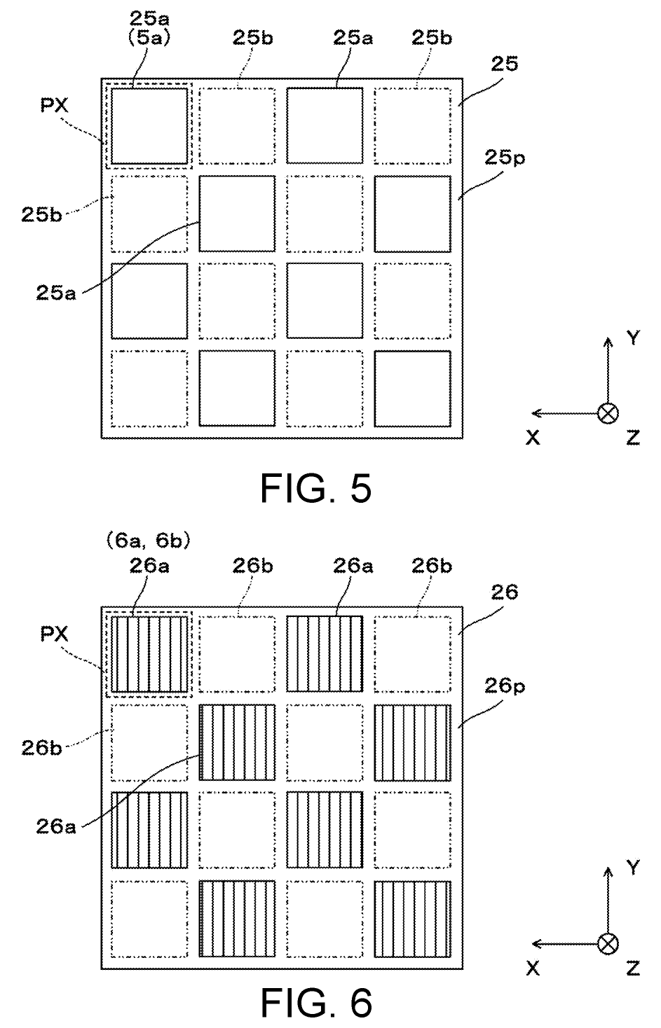

FIG. 5 is a rear view illustrating the image display panel 25. The image display panel 25 includes a light-transmissive planar plate 25p having display regions 25a, which form the video light ML, and first outside light transmitting regions 25b, which transmit the outside light OL. At the planar plate 25p, the multiple display regions 25a and the multiple first outside light transmitting regions 25b are arranged in a matrix along the XY plane. In other words, the display regions 25a and the first outside light transmitting regions 25b are alternately arranged in the plan view.

The display regions 25a are each a light emitting region 5a, in which a pixel PX is provided. One display region 25a corresponds to a pixel PX, and is a region where RGB three-color sub-pixels are arranged.

Note that each of the display regions 25a is not limited to a pixel group including the RGB three-color sub-pixels, and may instead be an individual R pixel, G pixel, or B pixel. In this case, for example, the first outside light transmitting regions 25b may be disposed at a ratio of one first outside light transmitting region 25b to three display regions 25a (R pixels, G pixels, or B pixels).

Each of the first outside light transmitting regions 25b is a non-display region where no pixel PX is provided, and transmits the outside light OL as it is. Each of the first outside light transmitting regions 25b is, for example, the light-transmissive planar plate 25p itself or an opening formed in the planar plate 25p. The first outside light transmitting regions 25b are each, for example, a square region each side of which has a length in a range between 3 μm and 20 μm. Note that each of the first outside light transmitting regions 25b does not necessarily have a square shape, and may instead have a rectangular shape, a quadrangular shape with rounded corners, a circular shape, or an elliptical shape.

FIG. 6 is a rear view illustrating the polarizing element 26. The polarizing element 26 includes a light-transmissive planar plate 26p having polarizing regions 26a, which restrict the video light ML to transmit only the video light ML polarized in a predetermined polarization direction, and second outside light transmitting regions 26b, which transmit the outside light OL. At the planar plate 26p, the multiple polarizing regions 26a and the multiple second outside light transmitting regions 26b are arranged in a matrix along the XY plane. In other words, the polarizing regions 26a and the second outside light transmitting regions 26b are alternately arranged in the plan view. The polarizing regions 26a are disposed at the positions corresponding to the display regions 25a of the image display panel 25. The second outside light transmitting regions 26b are disposed at the positions corresponding to the first outside light transmitting regions 25b of the image display panel 25.

The polarizing regions 26a each include a polarizing plate 6a and a quarter-wave plate 6b arranged sequentially from the side facing the display unit 40. The polarizing regions 26a convert the video light ML into light linearly polarized in a predetermined polarization direction and then convert the linearly polarized light into circularly polarized light.

The polarizing plate 6a restricts the video light ML to transmit only first polarized light P1 polarized in the predetermined polarization direction, specifically, longitudinally or vertically polarized light. The polarizing plate 6a is, for example, a wire-grid polarizing element, and has polarization characteristics according to the direction of the pattern of a fine metal grid made, for example, of aluminum.

The quarter-wave plate 6b has a principal axis, for example, between the X direction and the Y direction, and converts the video light ML from linearly polarized light into circularly polarized light. The video light ML being circularly polarized light means that in terms of the vibration of the electric field component or the magnetic field component of the video light ML, the direction of the vibration rotates at the frequency of the video light ML in a plane perpendicular to the traveling direction of the light, and that the amplitude of the vibration is fixed irrespective of the direction thereof. Right-handed circularly polarized light has an electric field component having a vibration direction that rotates clockwise when viewed from an observer facing the beam traveling toward the observer, and left-handed circularly polarized light has an electric field component having a vibration direction that rotates counterclockwise. Note, however, in the present specification that as long as the video light ML primarily contains right-handed circularly polarized light, the video light ML is assumed to be right-handed circularly polarized light RCP even when the video light ML contains, for example, linearly polarized light polarized in a specific direction. Similarly, as long as the video light ML primarily contains left-handed circularly polarized light, the video light ML is assumed to be left-handed circularly polarized light LCP. In the present specification, the right-handed circularly polarized light RCP is also called right circularly polarized light RCP, and the left-handed circularly polarized light LCP is also called left circularly polarized light LCP. The quarter-wave plate 6b may be produced by applying a photo-cross-linkable polymer liquid crystal material onto a transparent resin base to form a thin film and fixing the alignment state of the liquid crystal molecules, or may be produced by processing a birefringent crystal material such as quartz crystal into a thin plate.

Each of the second outside light transmitting regions 26b is a non-polarizing region that transmits the outside light OL as it is, and is, for example, the light-transmissive planar plate 26p itself or an opening formed in the planar plate 26p. In consideration of assembly accuracy and the like, the second outside light transmitting regions 26b are desirably larger than the first outside light transmitting regions 25b of the image display panel 25 by, for example, about 10%. Note that the second outside light transmitting regions 26b may instead be as large as the first outside light transmitting regions 25b. Note that each of the second outside light transmitting regions 26b does not necessarily have a square shape, and may instead have a rectangular shape, a quadrangular shape with rounded corners, a circular shape, or an elliptical shape.

In the above description, the video light ML becomes circularly polarized light after passing through the display regions 25a of the image display panel 25, which is the display member 2b, and the polarizing regions 26a of the polarizing element 26. The outside light OL becomes a light component different from the video light ML after passing through the first outside light transmitting regions 25b of the image display panel 25, which is the display member 2b, and the second outside light transmitting regions 26b of the polarizing element 26.

Returning to FIG. 2, the imaging system 50 is disposed on the observer's face side, that is, the −Z side of the display unit 40 or the composite display member 20, and covers the front of the eye. The imaging system 50 functions as a positive lens or a collimator having positive power and affecting the video light ML. The imaging system 50 includes a polarizing diffractive lens 51. The polarizing diffractive lens 51 is an optical element affecting light differently in accordance with the polarization of the light.

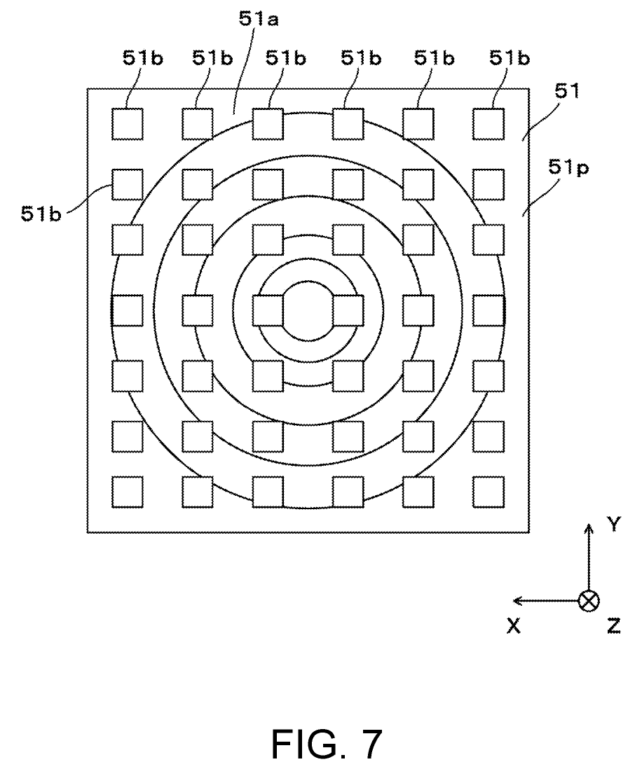

FIG. 7 is a rear view illustrating the polarizing diffractive lens 51. The polarizing diffractive lens 51 is a plate-shaped member extending along the XY plane. The polarizing diffractive lens 51 includes a planar plate 51p having a diffracting region 51a, which diffracts and collects the video light ML, and non-diffracting regions 51b, which transmit the outside light OL. At the planar plate 51p, the multiple non-diffracting regions 51b are arranged in a matrix along the XY plane. In other words, in the polarizing diffractive lens 51, the multiple non-diffracting regions 51b are arranged in the form of islands, and the remaining region serves as the diffracting region 51a in the plan view. As a result, the outside light OL having passed through the non-diffracting regions 51b disposed in the form of islands is not diffracted but reaches the eye EY.

The polarizing diffractive lens 51, specifically, the diffracting region 51a has refractive power selectively affecting the polarization of the video light ML. In other words, the diffracting region 51a of the polarizing diffractive lens 51 functions as a lens affecting the video light ML output from the display unit 40. That is, the diffracting region 51a forms images of the multiple pixels that constitute the image display panel 25 as a whole, and enables the observation of a video formed on the image display panel 25 as virtual images. The non-diffracting regions 51b of the polarizing diffractive lens 51 function as plane-parallel plates or transmissive regions for the outside light OL passing through the display unit 40. As a result, the outside light OL passes straight through the non-diffracting regions 51b of the polarizing diffractive lens 51, and is observed as a direct-view image.

The diffracting region 51a of the polarizing diffractive lens 51 alone functions as a positive lens when predetermined circularly polarized light is incident thereon. The polarizing diffractive lens 51 alone functions as a negative lens when circularly polarized light that is the reversal of the predetermined circularly polarized light described above is incident thereon. The polarizing diffractive lens 51 includes a liquid crystal layer in which the orientation axis of the liquid crystal molecules more angularly rotates as the liquid crystal molecules are farther away from the optical axis AX so that an initial geometric phase is formed, and the increase is periodically repeated. The direction in which the orientation axis of the liquid crystal molecules of the polarizing diffractive lens 51 more angularly rotates depends on the polarization of the incident light. The polarizing diffractive lens 51 is also called a liquid crystal diffractive lens, a geometric-phase (GP) lens, two-dimensional anisotropic diffractive optical elements, or a geometric phase lens.

Each of the non-diffracting regions 51b is a region that transmits the outside light OL as it is, and is, for example, an opening formed in the planar plate 51p of the polarizing diffractive lens 51 or a region in which the liquid crystal molecules are arranged in disorder in the polarizing diffractive lens 51. In the present embodiment, the non-diffracting regions 51b are as large as or substantially as large as the second outside light transmitting regions 26b of the polarizing element 26. The non-diffracting regions 51b each do not necessarily have a square shape, and may instead have a rectangular shape, a quadrangular shape with rounded corners, a circular shape, or an elliptical shape. In particular, when the non-diffracting regions 51b each have a quadrangular shape with rounded corners, a circular shape, or an elliptical shape, unnecessary diffraction at the corners of the non-diffracting regions can be prevented.

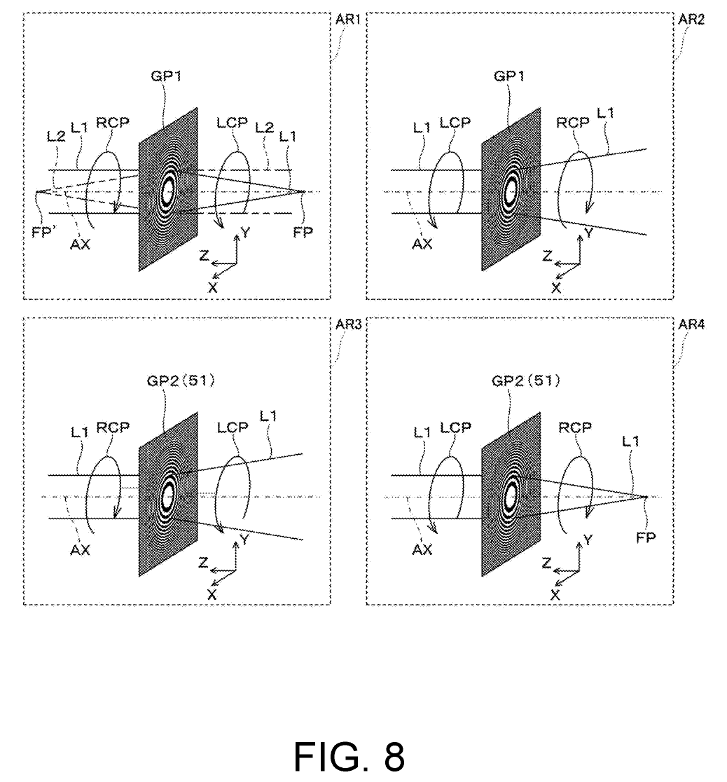

FIG. 8 illustrates the function of the polarizing diffractive lens 51. In FIG. 8, a first region AR1 shows a first operation example of a first-type polarizing diffractive lens GP1, and a second region AR2 shows a second operation example of the first-type polarizing diffractive lens GP1. In FIG. 8, a third region AR3 shows a first operation example of a second-type polarizing diffractive lens GP2, and a fourth region AR4 shows a second operation example of the second-type polarizing diffractive lens GP2. The polarizing diffractive lens 51 shown in FIG. 2 and the like is a second-type polarizing diffractive lens GP2.

The polarizing diffractive lens GP1 has the following two functions: the function, performed when the right circularly polarized light RCP, which is collimated second circularly polarized light such as a beam L1 indicated by the solid line is incident from the left of the figure, of converting the right circularly polarized light RCP into the left circularly polarized light LCP, which is first circularly polarized light and causing the left circularly polarized light LCP to converge into a spot at a focal point FP; and the function, performed when the collimated left circularly polarized light LCP such as the beam L1 indicated by the solid line is incident from the left of the figure, of converting the left circularly polarized light LCP into the right circularly polarized light RCP and causing the right circularly polarized light RCP to diverge. Note that the polarizing diffractive lens GP1 has the function, performed when the right circularly polarized light RCP, which diverges from a focal point FP' on the left of the figure such as a beam L2 indicated by the two-dot chain line, is incident, of converting the right circularly polarized light RCP into the left circularly polarized light LCP and collimating the left circularly polarized light LCP. That is, the polarizing diffractive lens GP1 reverses the polarization rotation direction of the right circularly polarized light RCP while functioning as a positive lens having a predetermined focal length and affecting the right circularly polarized light RCP. The polarizing diffractive lens GP1 reverses the polarization rotation direction of the left circularly polarized light LCP while functioning as a negative lens having a focal length the absolute value of which is equal to that of the positive lens described above and affecting the left circularly polarized light LCP. That is, the polarizing diffractive lens GP1 is an optical element having positive power affecting the right circularly polarized light RCP and negative power affecting the left circularly polarized light LCP.

The polarizing diffractive lens GP2 has the function, performed when the right circularly polarized light RCP, which is the collimated second circularly polarized light such as the beam L1 indicated by the solid line, is incident from the left of the figure, of converting the right circularly polarized light RCP into the left circularly polarized light LCP, which is the first circularly polarized light, and causing the left circularly polarized light LCP to diverge. The polarizing diffractive lens GP2 has the function, performed when the collimated left circularly polarized light LCP such as the beam L1 indicated by the solid line, is incident from the left of the figure, of converting the left circularly polarized light LCP into the right circularly polarized light RCP, and causing the right circularly polarized light RCP to converge into a spot at the focal point FP. That is, the polarizing diffractive lens GP2 reverses the polarization rotation direction of the left circularly polarized light LCP while functioning as a positive lens having a predetermined focal length and affecting the left circularly polarized light LCP. The polarizing diffractive lens GP2 reverses the polarization rotation direction of the right circularly polarized light RCP while functioning as a negative lens having a focal length the absolute value of which is equal to that of the positive lens described above and affecting the right circularly polarized light RCP. That is, the polarizing diffractive lens GP2 is an optical element having negative power affecting the right circularly polarized light RCP and positive power affecting the left circularly polarized light LCP.

Each of the polarizing diffractive lenses GP1 and GP2 has refractive index anisotropy distribution grasped as a large number of annular bands formed in a plane around the optical axis AX, and functions as a diffractive lens in accordance with the refractive index anisotropy distribution and the polarization state of the incident light. Specifically, in the polarizing diffractive lenses GP1 and GP2, when each of which has a refractive index anisotropy distribution which causes the azimuth of the optic axis of the polarizing diffractive lens to rotate (in practice, repeatedly rotate within a range between 0 and π) in two directions perpendicular to each other and the optical axis AX, which is at the center of the lens, as the two directions extend away from the optical axis AX, the thus configured polarizing diffractive lens cause specific circularly polarized light incident thereon to have a geometric phase, and the circularly polarized light is diffracted at a diffraction angle that reflects the length of the cycle of the rotation of the optic axis with respect to the azimuth in each of the two directions, so that the polarization state of the circularly polarized light is reversed. Each of the polarizing diffractive lenses as a whole diffracts the specific circularly polarized light in correspondence with the power formed by the lens shape, and reverses the polarization state of the circularly polarized light, for example, from right circularly polarized light before passing through the lens to left circularly polarized light after passing through the lens.

Although not shown, each of the polarizing diffractive lenses GP1 and GP2 is configured with a transparent substrate on which a thin-film liquid-crystal-containing material layer is formed, and has a thin plate shape as a whole. The liquid-crystal-containing material layer contains a predetermined liquid crystal material, and the orientation axis of the liquid crystal molecules is made parallel, for example, to the X direction in a region close to the optical axis AX so that an initial geometric phase is formed, and gradually rotates in an XY plane as the liquid crystal molecules are located away from the optical axis AX, that is, in accordance with the distance from or the radius around the optical axis AX. That is, the angle of rotation of the orientation axis of the liquid crystal molecules increases in accordance with the distance from the optical axis AX, and the increase is cyclically repeated. In a liquid crystal compound layer, the liquid crystal molecules are arranged in the Z direction parallel to the optical axis AX, for example, with the orientation axis of the liquid crystal molecules maintained constant. Note that the angle of rotation of the orientation axis of the liquid crystal molecules increases in opposite directions in the polarizing diffractive lenses GP1 and GP2. To manufacture the polarizing diffractive lenses GP1 and GP2, for example, a liquid-crystal-containing material film that is a mixture of a liquid crystal material and an ultraviolet curable organic material layer is formed on a substrate, and the liquid-crystal-containing material film is two-dimensionally scanned with UV laser light having a predetermined polarization state, so that the organic material layer is cured while the orientation axis of the liquid crystal molecules is adjusted. The orientation axis of the liquid crystal molecules can thus be three-dimensionally controlled and fixed in the liquid-crystal-containing material layer, so that the liquid crystal compound layer described above, in which the angle of the rotation of the orientation axis increases as the liquid crystal molecules are located away from the optical axis AX, is produced. The thus produced polarizing diffractive lens GP1 itself is known, for example, as a polarization-dependent liquid crystal Fresnel lens (see Kohei Noda, et al., Applied Optics, February 10 2017, Vol. 56, No. 5: 1302, for example).

The polarizing diffractive lenses GP1 and GP2 can be produced also by a method for manufacturing a liquid crystal optical body described in JP-A-2008-501147.

The polarizing diffractive lenses GP1 and GP2 do not need to be different from each other, and the polarizing diffractive lens GP2 is obtained by rotating the polarizing diffractive lens GP1 around the Y-axis by 180° and flipping the rotated polarizing diffractive lens GP1 around. That is, the polarizing diffractive lenses GP1 and GP2 can each function as both a positive lens and a negative lens for the same circularly polarized light by flipping the lens around. The reason for this is that in the polarizing diffractive lenses GP1 and GP2, since the angle of rotation of the orientation axis of the liquid crystal molecules is so increased that the orientation axis rotates in a specific direction in accordance with the distance from the optical axis AX as described above, the directions of the rotation of the orientation axis at an absolute-value distance from the optical axis AX, for example, in the ±X direction perpendicular thereto coincide with each other, so that the rotation direction of the orientation axis is reversed when the polarizing diffractive lenses GP1 and GP2 are viewed from the rear side.

The focal lengths of the polarizing diffractive lenses GP1 and GP2 can be increased or decreased by changing the manufacturing method or the liquid crystal material. In the liquid crystal compound layer, for example, when the angle of the rotation of the orientation axis of the liquid crystal molecules is increased as the liquid crystal molecules are located away from the optical axis AX, increasing the rate of the increase in the angle of rotation at the distance from or the radius around the optical axis AX, that is, shortening the length of the cycle of the rotation of the orientation axis can increase the absolute value of the positive or negative power of each of the polarizing diffractive lenses GP1 and GP2, so that the focal length of the lens can be adjusted. When the circularly polarized beam L1 passes through the polarizing diffractive lenses GP1 and GP2, the loss of the beam L1 is close to zero, so that the polarizing diffractive lenses GP1 and GP2 have almost 100% transmittance.

When linearly polarized light enters the polarizing diffractive lens GP1, the right circularly polarized light RCP and the left circularly polarized light LCP contained in the linearly polarized light behave differently. One of the components that is the right circularly polarized light RCP passes through the polarizing diffractive lens GP1, which causes the component to converge, whereas the other component that is the left circularly polarized light LCP passes through the polarizing diffractive lens GP1, which causes the component to diverge, and the polarization rotation directions of the two types of polarized light is reversed.

In the imaging system 50, the polarizing diffractive lens 51 is the polarizing diffractive lens GP2 shown in FIG. 8. When the video light ML incident from the display unit 40 is the left circularly polarized light LCP, the polarizing diffractive lens 51 functions as an optical element having positive power affecting the video light ML, and reverses the polarization rotation direction to change the video light ML to the right circularly polarized light RCP while reducing the degree of divergence of the video light ML.

The second display optical system 103b is optically the same as the first display optical system 103a or is a horizontally flipped version of the first display optical system 103a, and will therefore not be described in detail.

Note that an optical apparatus that is the first virtual image display apparatus 100A from which the controller 80 is excluded is called an optical unit 100. Similarly, an optical apparatus that is the second virtual image display apparatus 100B from which the controller 80 is excluded is called the optical unit 100.

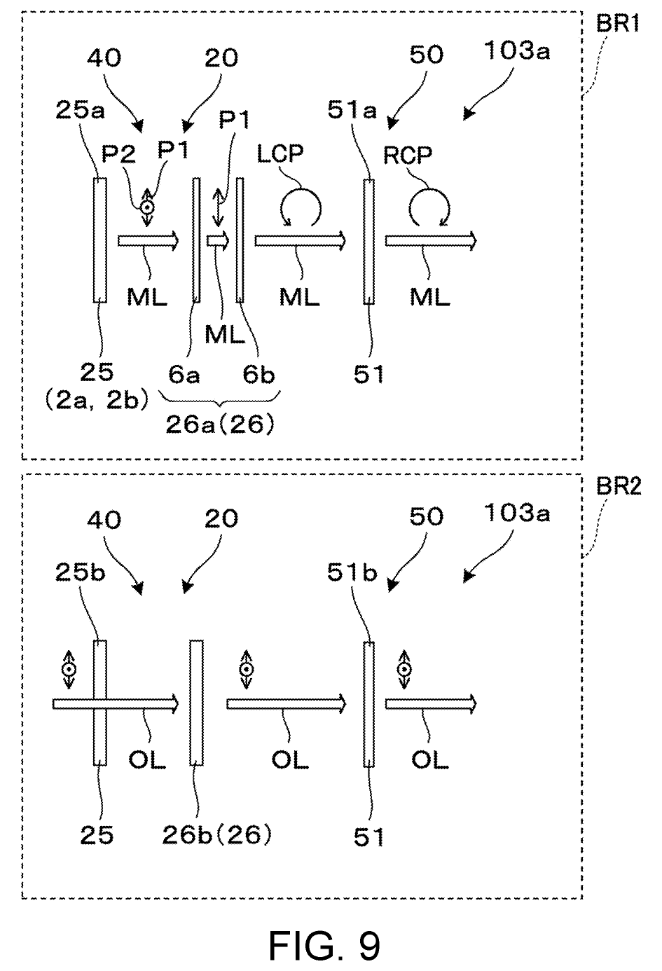

FIG. 9 illustrates the state of light in the first display optical system 103a. In FIG. 9, a first region BR1 shows the state of the video light ML, and a second region BR2 shows the state of the outside light OL.

During the video observation, the video light ML is output from the display regions 25a of the image display panel 25. The video light ML output from the image display panel 25 contains the first polarized light P1, which is longitudinally polarized light, and second polarized light P2, which is laterally polarized light. The video light ML output from the image display panel 25 is incident on the polarizing element 26. The video light ML passes through the polarizing plate 6a, which constitutes the polarizing region 26a of the polarizing element 26, and is restricted to the first polarized light P1. The video light ML having passed through the polarizing plates 6a passes through the quarter-wave plate 6b, which converts the video light ML from the first polarized light P1 into the left circularly polarized light LCP. The imaging system 50 has positive power affecting the video light ML that is the left circularly polarized light LCP, so that the video light ML can be observed.

During the outside light observation, the outside light OL passes through the first outside light transmitting regions 25b of the image display panel 25 and is incident on the polarizing element 26. The outside light OL passes through the second outside light transmitting regions 26b of the polarizing element 26. The outside light OL having passed through the second outside light transmitting regions 26b passes through the non-diffracting regions 51b of the polarizing diffractive lens 51 of the imaging system 50, so that the outside light OL can be observed. Note that when the outside light OL also passes through the diffracting region 51a, the power thereof affecting the outside light OL is substantially zero, so that scattered outside light OL is observed.

The virtual image display apparatus 100A or the display optical system 103a, which perform the display operation described above, enables see-through display in which the video light ML and the outside light OL are superimposed on each other.

The above description has been made with reference to the case where the image display panel 25 has the three-color sub-pixels, but when the imaging system 50 produces a large amount of chromatic aberrations, the imager 2a or the image display panel 25 can be configured only with single-color pixels.

Note that polarizing plates (not shown) that restrict the second polarized light P2 may be disposed on a side of the image display panel 25 that is the side facing the outside space. The polarizing plates prevent the outside light OL from passing through the display regions 25a of the image display panel 25 when the image display panel 25 does not emit light. Note that the polarizing plates may be replaced with light shielding members disposed at the positions corresponding to the display regions 25a of the image display panel 25 on a side of the image display panel 25 that is the side facing the outside space so that the outside light OL does not pass through the display regions 25a.

The virtual image display apparatuses 100A and 100B or the optical unit 100 according to the first embodiment described above includes the display unit 40, which outputs the circularly polarized video light ML and transmits the outside light OL, and the polarizing diffractive lens 51 having the diffracting region 51a, which collects the video light ML output from the display unit 40, and the non-diffracting regions 51b, which transmit the outside light OL passing through the display unit 40.

In the virtual image display apparatuses 100A and 100B or the optical unit 100 described above, since the polarizing diffractive lens 51 has positive refractive power affecting the circularly polarized video light ML from the display unit 40, a video formed by the display unit 40 can be observed even when the display unit 40 is disposed in front of the eyes. In addition, since the polarizing diffractive lens 51 has the non-diffracting regions 51b, the outside light OL is not diffracted thereby but passes therethrough as it is, so that the outside light OL can be observed. As a result, the see-through virtual image display apparatuses 100A and 100B that allow both video observation and outside light observation can be reduced in thickness.

### Second embodiment

A virtual image display apparatus and the like according to a second embodiment will be described below. Note that the virtual image display apparatus according to the second embodiment is a partially changed version of the virtual image display apparatus according to the first embodiment, and the portions common to those of the virtual image display apparatus according to the first embodiment will not be described.

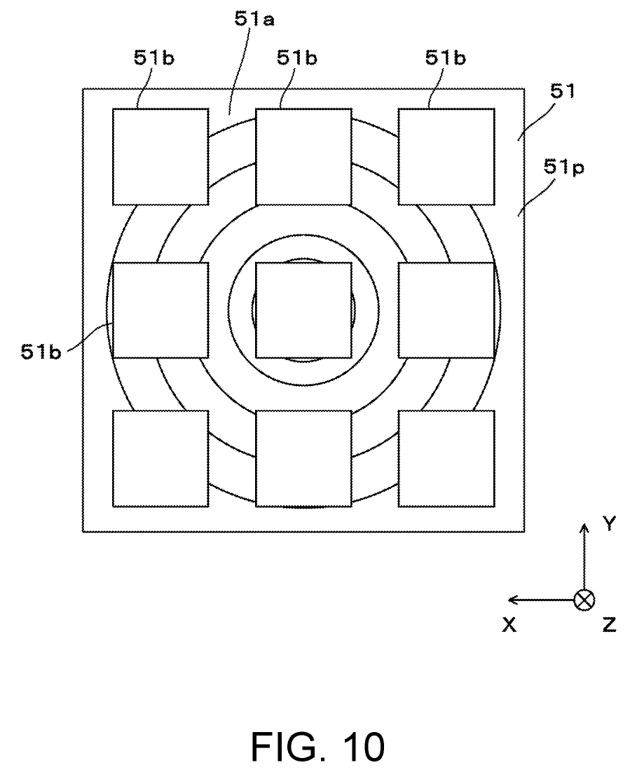

In the virtual image display apparatus 100A or the optical unit 100 shown in FIG. 10, the non-diffracting regions 51b of the polarizing diffractive lens 51 are larger than the second outside light transmitting regions 26b of the polarizing element 26. The size of each of the non-diffracting regions 51b is determined in consideration of the contrast between the outside light OL and the video light ML. Specifically, the non-diffracting regions 51b are about twice to five hundred times as large as the second outside light transmitting regions 26b. The polarizing diffractive lens 51 can thus transmit without waste the outside light OL captured by the display unit 40.

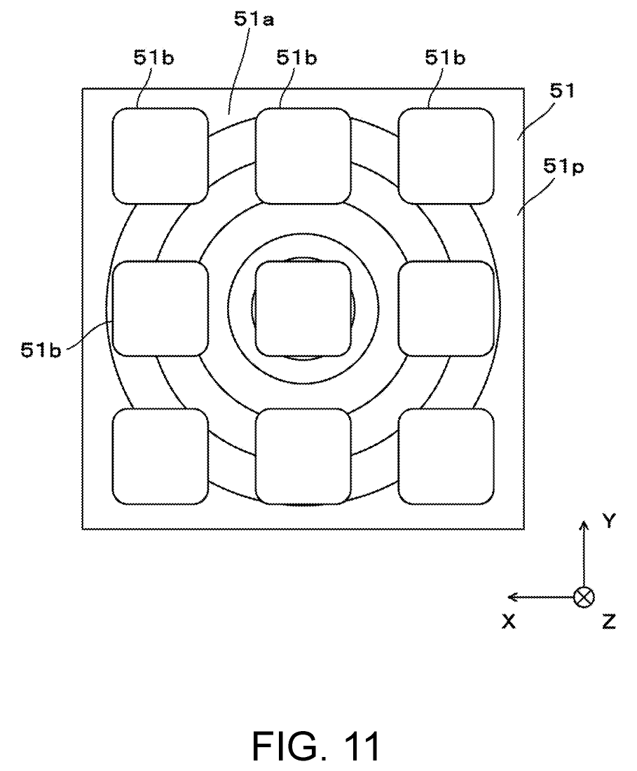

The non-diffracting regions 51b each do not necessarily have a square shape shown in FIG. 10, and may instead have a rectangular shape, a quadrangular shape with rounded corners, a circular shape, or an elliptical shape. FIG. 11 shows a variation of the shape of the non-diffracting regions 51b, and the non-diffracting regions 51b each have a quadrangular shape with rounded corners. In other words, the non-diffracting regions 51b each have a rounded shape at each of the corners of the quadrangular shape. The rounded shapes can prevent unnecessary diffraction at the corners of the non-diffracting regions 51b.

### Third embodiment

A virtual image display apparatus and the like according to a third embodiment will be described below. Note that the virtual image display apparatus according to the third embodiment is a partially changed version of the virtual image display apparatus according to the first embodiment, and portions common to those of the virtual image display apparatus according to the first embodiment will not be described.

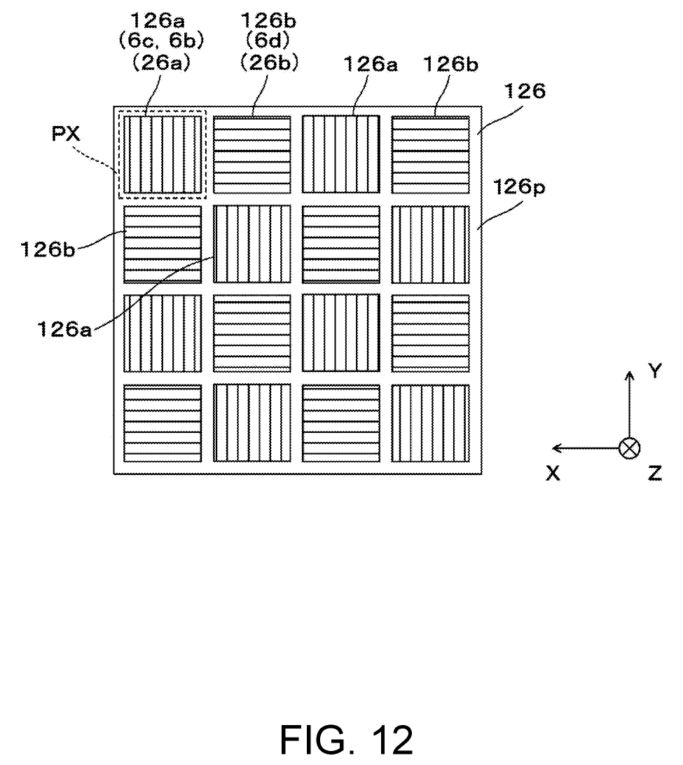

In the virtual image display apparatus 100A or the optical unit 100 shown in FIG. 12, a polarizing element 126 has a pattern of a composite of two types of polarizing elements. When passing through the polarizing element 126, the video light ML and the outside light OL have different polarization states. The polarizing element 126 includes a light-transmissive planar plate 126p, at which multiple first polarizing elements 126a and multiple second polarizing elements 126b are arranged in a matrix along the XY plane. In other words, the first polarizing elements 126a and the second polarizing elements 126b are alternately arranged in the plan view. The first polarizing elements 126a are disposed at the positions corresponding to the display regions 25a of the image display panel 25. The second polarizing elements 126b are disposed at the positions corresponding to the first outside light transmitting regions 25b of the image display panel 25.

The first polarizing elements 126a correspond to the polarizing regions 26a. The first polarizing elements 126a convert the video light ML into light linearly polarized in a predetermined polarization direction and then convert the linearly polarized light into circularly polarized light. The polarizing regions 26a each include a first polarizing plate 6c and the quarter-wave plate 6b arranged sequentially from the side facing the display unit 40. The first polarizing plate 6c restricts the video light ML to transmit only the first polarized light P1 polarized in a first polarization direction, specifically, longitudinally or vertically polarized light. The quarter-wave plate 6b converts the video light ML from linearly polarized light into circularly polarized light.

The second polarizing elements 126b correspond to the second outside light transmitting regions 26b. The second polarizing elements 126b restrict the outside light OL to transmit only light linearly polarized in a polarization direction different from the direction in which the video light ML is polarized. The second outside light transmitting regions 26b each include a second polarizing plate 6d. The second polarizing plate 6d restricts the outside light OL to transmit only the second polarized light P2 polarized in a second polarization direction perpendicular to the first polarization direction, specifically, laterally or horizontally polarized light.

In the present embodiment, even when the outside light OL having passed through the second polarizing elements 126b, which constitute the second outside light transmitting regions 26b, is linearly polarized light, the outside light OL passing through the non-diffracting regions 51b of the polarizing diffractive lens 51 reaches the eye EY as it is. The outside light OL incident on the diffracting region 51a of the polarizing diffractive lens 51 is scattered.

### Fourth embodiment

A virtual image display apparatus and the like according to a fourth embodiment will be described below. Note that the virtual image display apparatus according to the fourth embodiment is a partially changed version of the virtual image display apparatus according to the first embodiment, and portions common to those of the virtual image display apparatus according to the first embodiment will not be described.

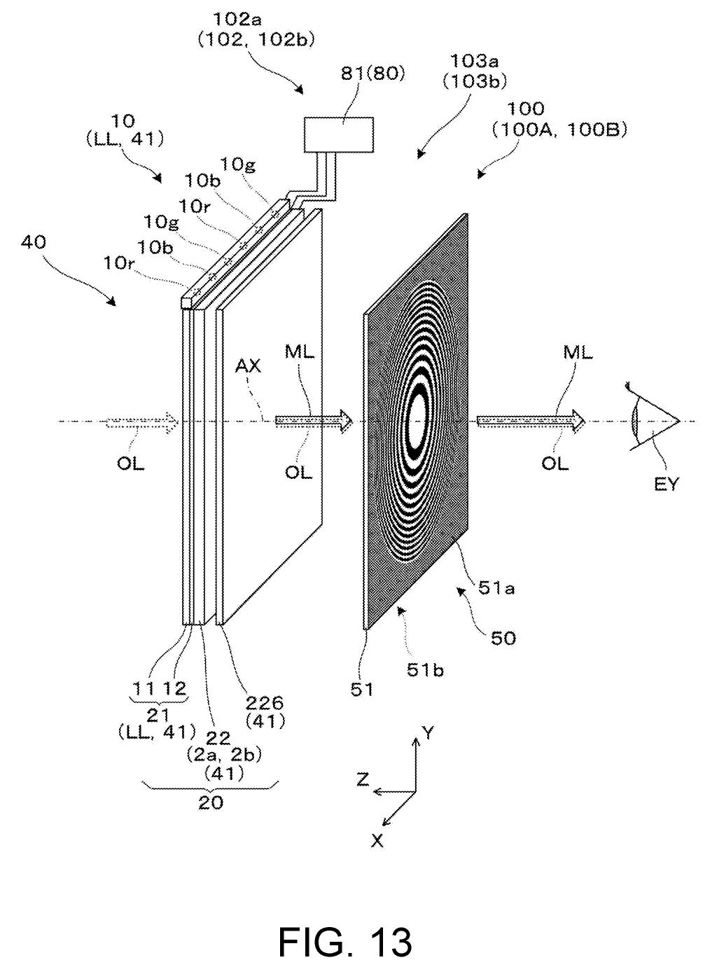

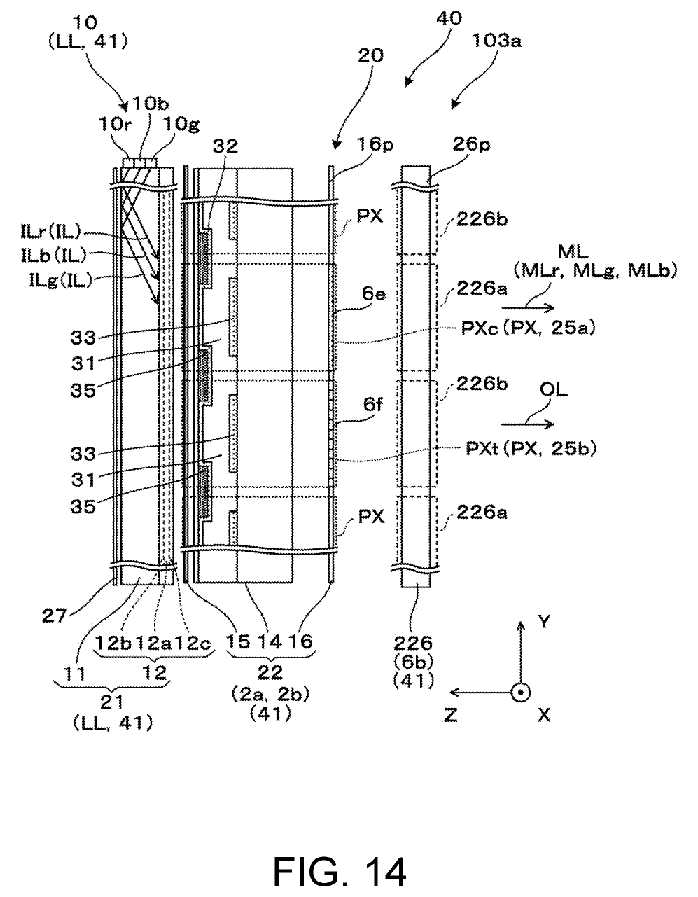

FIG. 13 is a conceptual perspective view illustrating the structure of the first display optical system 103a of the first virtual image display apparatus 100A. FIG. 14 is a conceptual side cross-sectional view illustrating the structure of the display unit 40.

The display unit 40 includes a light source 10, which generates three types of color light as illumination light in a time division manner, and the composite display member 20, which forms and outputs the video light ML. The light source 10 is also a portion of the first display driver 102a shown in FIG. 1, and is disposed in the vicinity above the upper side of a light guide member 21, which will be described later, out of the composite display member 20 so as to supply illumination light to the light guide member 21 via the upper end side thereof. The composite display member 20 of the display unit 40 is disposed close to the eye EY with the imaging system 50 interposed therebetween, and enables observation of virtual images formed by the video light ML and see-through viewing of the outside space. In the first display optical system 103a, the distance between the eye EY and the imaging system 50 in the direction of the optical axis AX is, for example, in the range between about 10 mm and 20 mm. The distance between a transmissive liquid crystal panel 22 of the display unit 40 and the imaging system 50 in the direction of the optical axis AX is, for example, in the range between about 5 mm and 25 mm.

The light source 10 includes one or more R light emitters 10r, which generate red light, one or more B light emitters 10b, which generate blue light, and one or more G light emitters 10g, which generate green light. The R light emitters 10r, the B light emitters 10b, and the G light emitters 10g are self-luminous elements, and are, for example, organic light emitting diodes (OLEDs), but may instead be other light emitting diodes such as micro light emitting diodes (μLED) made of an inorganic material. A multiplexer/demultiplexer including a beam splitter that assists diffusion of the illumination light can be incorporated between the light source 10 and the light guide member 21 of the composite display member 20.

The composite display member 20 is a plate-shaped member extending along the XY plane perpendicular to the optical axis AX, and includes the light guide member 21, the transmissive liquid crystal panel 22, and a polarizing element 226 arranged sequentially from the side facing the display unit 40. The composite display member 20 has a structure in which the light guide member 21, the transmissive liquid crystal panel 22, and the polarizing element 226 are layered on each other and integrated into a single unit by a frame that is not shown. The light guide member 21 and the transmissive liquid crystal panel 22 are disposed close to each other at a distance smaller than or equal to a predetermined value. The transmissive liquid crystal panel 22 is the imager 2a, which forms the video light ML. Note that the transmissive liquid crystal panel 22 is the display member 2b, and has multiple pixels PX (see FIG. 14) arranged in a matrix along the XY plane.

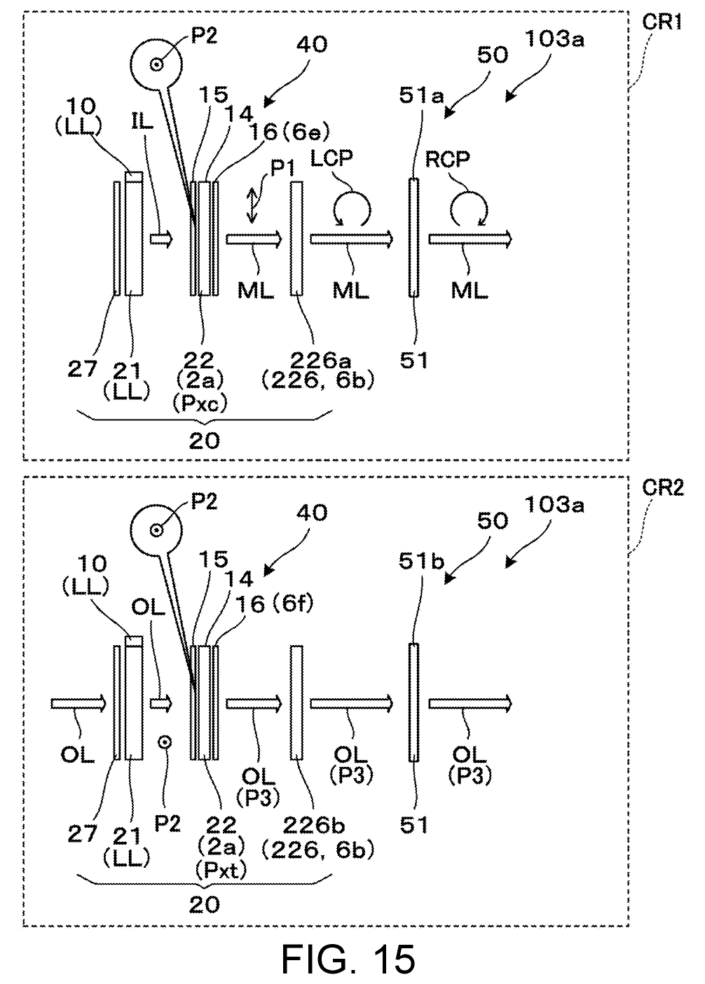

An outer polarizing plate 27 (see FIG. 14), which restricts the polarization of the outside light OL, is provided on a side of the light guide member 21 that is the side facing the outside space. The outer polarizing plate 27 restricts the outside light OL to transmit only the second polarized light P2 (see FIG. 15), which is light linearly polarized in a predetermined polarization direction, for example, laterally or horizontally polarized light.

The light source 10 and the light guide member 21 function as a backlight LL. In the present embodiment, the backlight LL, the transmissive liquid crystal panel 22, and the polarizing element 226 function as the light separating member 41, which separates the video light ML and the outside light OL from each other as different optical components.

The imaging system 50 is disposed on the observer's face side, that is, the −Z side of the display unit 40 or the composite display member 20, and covers the front of the eye. The imaging system 50 includes the polarizing diffractive lens 51.

Referring to FIG. 14, the light source 10 generates three types of color illumination light ILr, ILg, and ILb from the light emitters 10r, 10g, and 10b as illumination light IL, and supplies the three types of color illumination light ILr, ILg, and ILb to the light guide member 21 of the composite display member 20.

The light guide member 21 is a light guide plate 11 to which a ferroelectric liquid crystal plate 12 is fixed. The multiple types of illumination light ILr, ILg, and ILb from the light source 10 enter the light guide plate 11 via the upper end thereof and are coupled to the interior of the light guide plate 11. The light guide plate 11 causes the multiple types of illumination light ILr, ILg, and ILb incident from the light source 10 to propagate downward.

The ferroelectric liquid crystal plate 12 is a device that performs a switch-type operation in accordance with a drive signal from the drive circuit 81 shown in FIG. 13, and can switch its state between a scattering state (ON state) in which the illumination light IL (ILr, ILg, and ILb) is output out of the light guide plate 11 and a transparent state (OFF state) in which the ferroelectric liquid crystal plate 12 transmits the outside light OL and allows it to pass therethrough. The ferroelectric liquid crystal plate 12 includes a ferroelectric liquid crystal layer 12a sandwiched between a pair of bases 12b and 12c via transparent electrode layers that are not shown. The ferroelectric liquid crystal layer 12a is made, for example, of a reverse-mode polymer dispersed liquid crystal material, and operates in the transparent state when no electric field is applied, whereas it operates in the scattering state when an electric field is applied (see JP-A-6-308543, for example). The ferroelectric liquid crystal plate 12 can switch its state between the ON state and the OFF state not on a pixel basis across the pixels PX but on an entire surface basis. Note that the ferroelectric liquid crystal layer 12a may operate in the transparent state when an electric field is applied, and may operate in the scattering state when no electric field is applied.

The transmissive liquid crystal panel 22 includes a liquid crystal modulating member 14 and a pair of polarizing members 15 and 16, which sandwich the liquid crystal modulating member 14. In this case, the transmissive liquid crystal panel 22 is a modulator made, for example, of an in-plane-switching (IPS) liquid crystal material, and has video light generating pixels PXc and outside light transmitting pixels PXt. That is, in the transmissive liquid crystal panel 22, the multiple video light generating pixels PXc and the multiple outside light transmitting pixels PXt are arranged in a matrix along the XY plane. In other words, the video light generating pixels PXc and the outside light transmitting pixels PXt are alternately arranged in the plan view. The video light generating pixels PXc correspond to the display regions 25a, and the outside light transmitting pixels PXt correspond to the first outside light transmitting regions 25b.

The liquid crystal modulating member 14, when no electric field is applied, does not rotate the polarization direction of the incident light, but when an electric field is applied thereto, rotates the polarization direction of the incident light. The light-incident-side polarizing member 15 restricts the video light ML and the outside light OL to transmit only light linearly polarized in a predetermined polarization direction, for example, the second polarized light P2 (see FIG. 15), which is laterally or horizontally polarized light. The light-exiting-side polarizing member 16 includes a light-transmissive planar plate 16p including polarizing plates 6e at the positions corresponding to the video light generating pixels PXc and wave plates 6f at the positions corresponding to the outside light transmitting pixels PXt. That is, the planar plate 16p includes the multiple polarizing plates 6e and the multiple wave plates 6f arranged in a matrix along the XY plane. In other words, the polarizing plates 6e and the wave plates 6f are alternately arranged in the plan view. The polarizing plates 6e restrict the light incident thereon to transmit only linearly polarized light rotated by 90° with respect to the polarization direction of the linearly polarized light that the light-incident-side polarizing member 15 restricts, specifically, the first polarized light P1 (see FIG. 15), which is longitudinally or vertically polarized light. The wave plates 6f convert the linearly polarized outside light OL output from the light-incident-side polarizing member 15 into linearly polarized light P3 (see FIG. 15) polarized in a direction different from the polarization direction of the polarized light that the light-incident-side polarizing member 15 and the polarizing plates 6e restrict. The wave plates 6f align the linear polarization axis of the outside light OL with the axis of the quarter-wave plate 6b of the polarizing element 226.

The transmissive liquid crystal panel 22 can switch its state between the ON state and the OFF state on a pixel basis throughout the pixels PX in accordance with a drive signal from the drive circuit 81, and can partially transmit the incident light at any gray level between the ON state and the OFF state. To this end, the liquid crystal modulating member 14 includes not only a liquid crystal layer 31, a common electrode 32, pixel electrodes 33, and a black matrix 35 but also scan lines, signal lines, switching elements, and the like, none of which is shown.

Note that the transmissive liquid crystal panel 22 or the liquid crystal modulating member 14, when no electric field is applied, may rotate the polarization direction of the incident light, and when an electric field is applied, may not rotate the polarization direction of the incident light.

The entire polarizing element 226 is the quarter-wave plate 6b. The quarter-wave plate 6b, in combination with the polarizing plates 6e, is set as polarizing regions 226a to convert linearly polarized video light ML into circularly polarized light. Furthermore, the quarter-wave plate 6b, in combination with the wave plates 6f, is set as second outside light transmitting regions 226b to output linearly polarized outside light OL.

In the combination of the polarizing element 226 and the polarizing member 16 of the transmissive liquid crystal panel 22, note that regions through which the video light ML passes can be regarded as the polarizing regions 226a, and that regions through which the outside light OL passes can be regarded as the second outside light transmitting regions 226b.

In the present embodiment, the polarizing regions 226a of the polarizing element 226 may be multiple quarter-wave plates 6b arranged in a matrix along the XY plane in a light-transmissive planar plate. In this case, each of the second outside light transmitting regions 226b of the polarizing element 226 is a non-polarizing region that transmits the outside light OL as it is, and is, for example, a light-transmissive planar plate itself or an opening formed in the planar plate.

FIG. 15 illustrates the state of light in the first display optical system 103a. In FIG. 15, a first region CR1 shows a case where the first display optical system 103a operates in the video observation period and the display unit 40 displays video light. A second region CR2 shows a case where the first display optical system 103a operates in the outside light observation period and the display unit 40 displays no video light.

When the display unit 40 displays video light during the video observation period, the light emitters 10r, 10g, and 10b of the light source 10 emit light to supply the light guide member 21 with the multiple types of illumination light ILr, ILg, and ILb (see FIG. 14). At this timing, when the state of the ferroelectric liquid crystal plate 12 is switched to the ON state, which is a first state, and operates in the scattering state, the liquid crystal modulating member 14 is illuminated with the multiple types of illumination light ILr, ILg, and ILb as the second polarized light P2, which is laterally or horizontally polarized light, via the polarizing member 15 of the transmissive liquid crystal panel 22. That is, the video light generating pixels PXc, which constitute the transmissive liquid crystal panel 22, are illuminated. Multiple types of video light MLr, MLg, and MLb (see FIG. 14) having passed through the liquid crystal modulating member 14 are the multiple types of illumination light ILr, ILg, and ILb having polarization planes rotated in accordance with the drive signal, and only the first polarized light P1, which is longitudinally or vertically polarized light, is output via the polarizing member 16. The multiple types of video light MLr, MLg, and MLb output from the video light generating pixels PXc of the transmissive liquid crystal panel 22 are converted from the first polarized light P1 into the left circularly polarized light LCP via the quarter-wave plate 6b, which forms the polarizing regions 226a of the polarizing element 226.

When the display unit 40 displays no video light in the external light observation period, the light source 10 does not emit light, that is, operates in a turn-off state, and therefore stops supplying the illumination light IL to the light guide member 21. At this timing, when the state of the ferroelectric liquid crystal plate 12 is switched to the OFF state, which is a second state, and operates in the transparent state, the outside light OL travels straight so as to intersect with the light guide member 21, and enters the transmissive liquid crystal panel 22. At this point in time, the outside light transmitting pixels PXt of the transmissive liquid crystal panel 22 operate, for example, in a normally-off mode and are operated by the drive signal to transmit the outside light OL at the maximum transmittance, and the polarizing member 16 changes the second polarized light P2 out of the outside light OL incident on the outside light transmitting pixels PXt of the transmissive liquid crystal panel 22 to the linearly polarized light P3 having a predetermined polarization direction. The outside light OL that is the linearly polarized light P3 travels straight via the transmissive liquid crystal panel 22, that is, the outside light transmitting pixels PXt and exits. The outside light OL output from the outside light transmitting pixels PXt of the transmissive liquid crystal panel 22 remains as the linearly polarized light P3 and passes through the second outside light transmitting regions 226b of the polarizing element 226.

In the video observation period, the imaging system 50 has positive power, so that the video light ML can be observed, whereas in the outside light observation period, the power of the imaging system 50 is substantially zero, so that the outside light OL can be observed.

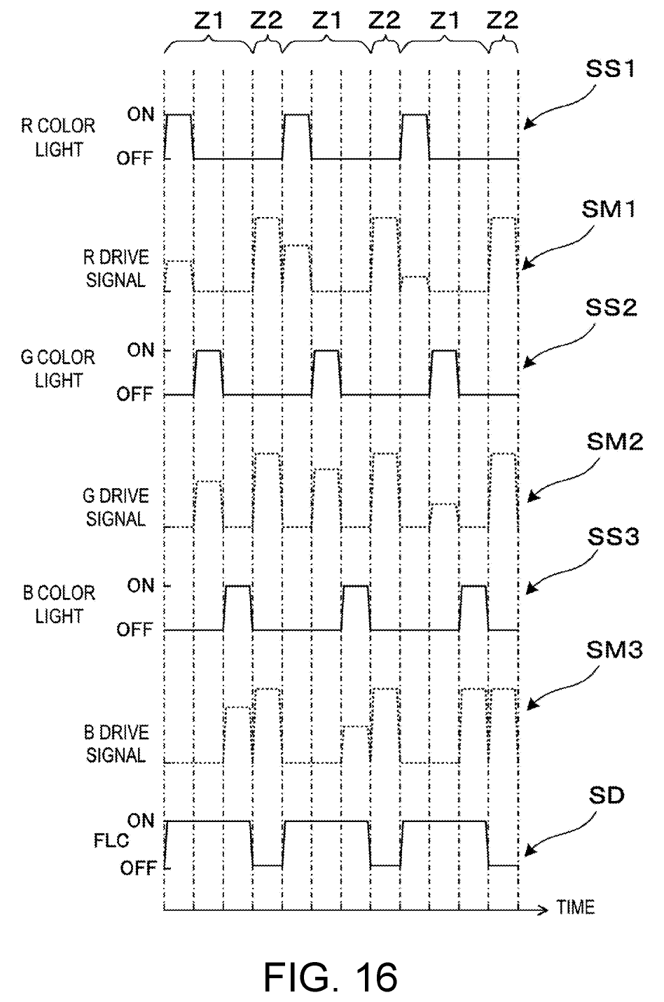

FIG. 16 is a timing chart illustrating the display operation performed by the display optical system 103a. The horizontal axis represents time, and indicates, sequentially from the top, a blinking signal SS1 supplied to the R light emitters 10r, an R drive signal SM1 for red display supplied to the liquid crystal modulating member 14, a blinking signal SS2 supplied to the G light emitters 10g, a G drive signal SM2 for green display supplied to the liquid crystal modulating member 14, a blinking signal SS3 supplied to the B light emitters 10b, a B drive signal SM3 for blue display supplied to the liquid crystal modulating member 14, and an on/off signal SD supplied to the ferroelectric liquid crystal plate (FLC) 12. In the operation of the first virtual image display apparatus 100A, each frame has a first sub-frame Z1, which is a video observation sub-frame, and a second sub-frame Z2, which is an outside light observation sub-frame.

In this case, when the first virtual image display apparatus 100A operates in the video observation period and the transmissive liquid crystal panel 22 displays video light, the three types of color video light MLr, MLg, and MLb are displayed in a time-division manner, whereas when the first virtual image display apparatus 100A operates in the outside light observation period and the transmissive liquid crystal panel 22 displays no video light, the outside light OL passes through the outside light transmitting pixels PXt of the transmissive liquid crystal panel 22.

In the above description, the display unit 40 incorporates the transmissive liquid crystal panel 22, and the transmissive liquid crystal panel 22 may be replaced with another type of imager 2a, for example, an organic electro-luminescence (EL) display. Note, however, that the imager 2a configured with an organic EL display desirably blocks the outside light OL while displaying an image, and transmits the outside light OL while stopping displaying the image. In this case, it is desirable to dispose a polarizing plate on the light exiting side of the organic EL display as the imager 2a.

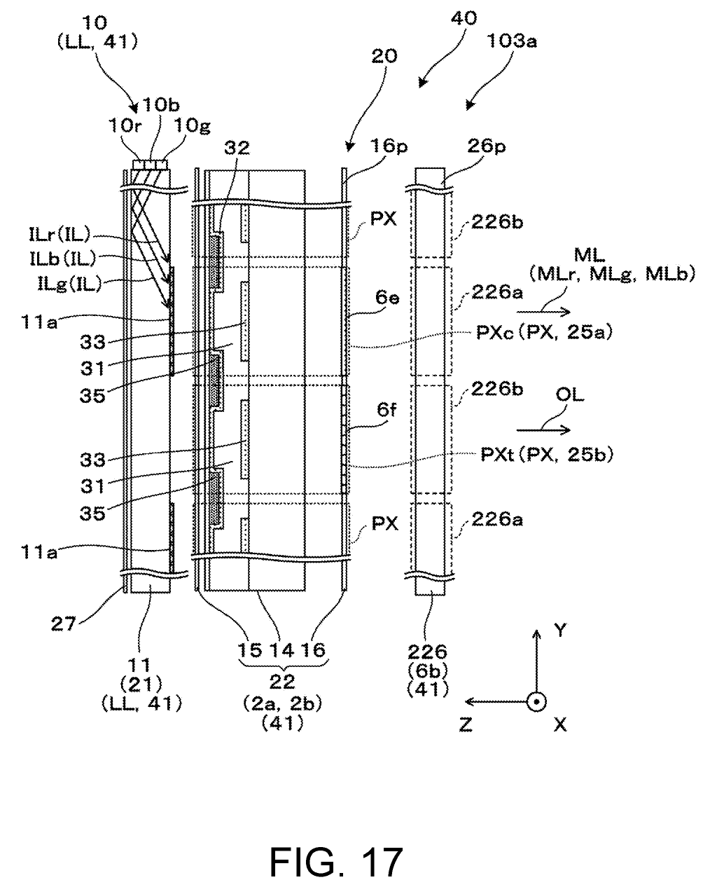

In the present embodiment, the ferroelectric liquid crystal plate 12 shown in FIG. 14 may not be provided, but scattering members 11a, which scatter the illumination light IL, may be provided on the light exiting side of the light guide plate 11 at the positions corresponding to the display regions 25a, as shown in FIG. 17.

### Variations and others

The present disclosure has been described above with reference to the embodiments, but is not limited to the embodiments described above, and can be implemented in various aspects to the extent that the aspects do not depart from the key points of the present disclosure. For example, variations below are conceivable.

The display unit 40 and the composite display member 20 incorporated therein are not limited to those shown in FIG. 3 and other figures by way of example, and various types of display panels can be employed.

In the display member 2b (image display panel 25 or transmissive liquid crystal panel 22), the numbers, sizes, arrangements, and other factors of the display regions 25a and the first outside light transmitting regions 25b can be changed as appropriate.

In the polarizing elements 26, 126, and 226, the numbers, sizes, arrangements, and other factors of the polarizing regions 26a and 226a and the second outside light transmitting regions 26b and 226b can be changed as appropriate.

In the polarizing diffractive lens 51, the numbers, sizes, arrangements, and other factors of the diffracting regions 51a and the non-diffracting regions 51b can be changed as appropriate.

In the imaging system 50, the polarizing diffractive lens 51 may be the polarizing diffractive lens GP1 shown in FIG. 8. In this case, the display unit 40 is so configured that the video light ML and the outside light OL incident on the quarter-wave plates 6b become the second polarized light P2 and the first polarized light P1, respectively. When the video light ML incident from the display unit 40 is the right circularly polarized light RCP, the polarizing diffractive lens GP1 functions as an optical element having positive power affecting the video light ML, and reverses the polarization rotation direction to change the right circularly polarized light RCP to the left circularly polarized light LCP while reducing the degree of divergence of the video light ML. When the outside light OL is the left circularly polarized light LCP, the polarizing diffractive lens GP1 functions as an optical element having negative power affecting the outside light OL, and reverses the polarization rotation direction to change the left circularly polarized light LCP to the right circularly polarized light RCP while reducing the degree of convergence of the outside light OL.

It is assumed in the above description that the HMD 200 is used with the HMD 200 mounted on the head. However, the virtual image display apparatuses 100A and 100B described above can also be used as a hand-held display that a user does not mount it on the head, but the user sees through it like binoculars. That is, in the present disclosure, the head mounted display also includes a hand-held display.

### SUMMARY OF THE PRESENT DISCLOSURE

The present disclosure will be summarized below as additional remarks.

### Additional Remark 1

A virtual image display apparatus including:

a display unit configured to output circularly polarized video light and transmit outside light; and

a polarizing diffractive lens having a diffracting region configured to collect the video light output from the display unit and a non-diffracting region configured to transmit the outside light passing through the display unit.

In the virtual image display apparatus described above, since the polarizing diffractive lens has positive refractive power affecting the circularly polarized video light from the display unit, a video formed by the display unit can be observed even when the display unit is disposed in front of the eyes. In addition, since the polarizing diffractive lens has the non-diffracting region, the outside light is not diffracted thereby but passes therethrough as it is, so that the outside light can be observed. As a result, a see-through virtual image display apparatus that allows both video observation and outside light observation can be reduced in thickness.

### Additional Remark 2

The virtual image display apparatus according to Additional Remark 1, wherein

in the polarizing diffractive lens, the non-diffracting region is configured with multiple non-diffracting regions arranged in the form of islands, and a remaining region serves as the diffracting region in a plan view.

As a result, the outside light having passed through the non-diffracting regions disposed in the form of islands is not diffracted but reaches the eyes.

### Additional Remark 3

The virtual image display apparatus according to any one of Additional Remarks 1 and 2, wherein

the display unit includes a display member and a polarizing element as a light separating member configured to separate the video light and the outside light,

the display member has a display region via which the video light is output and a first outside light transmitting region through which the outside light passes, and

the polarizing element has a polarizing region where the video light output from the display region is converted into circularly polarized light and a second outside light transmitting region through which the outside light passes.

The video light becomes circularly polarized light when passing through the display region of the display member and the polarizing region of the polarizing element. The outside light becomes a light component different from the video light after passing through the first outside light transmitting region of the display member and the second outside light transmitting region of the polarizing element.

### Additional Remark 4

The virtual image display apparatus according to Additional Remark 3, wherein

the display region is configured with multiple display regions and the first outside light transmitting region is configured with multiple first outside light transmitting regions, the multiple display regions and first outside light transmitting regions being disposed in the display member, and

in the polarizing element, the polarizing region is configured with multiple polarizing regions disposed at positions corresponding to the display regions, and the second outside light transmitting region is configured with multiple second outside light transmitting regions disposed at positions corresponding to the first outside light transmitting regions.

### Additional Remark 5

The virtual image display apparatus according to any one of Additional Remarks 3 and 4, wherein

the non-diffracting region is larger than the second outside light transmitting region.

The polarizing diffractive lens can thus transmit without waste the outside light captured by the display unit.

### Additional Remark 6

The virtual image display apparatus according to any one of Additional Remarks 1 to 5, wherein

the non-diffracting region has any one of a quadrangular shape, a quadrangular shape with rounded corners, a circular shape, and an elliptical shape.

In particular, when the non-diffracting region has a quadrangular shape with rounded corners, a circular shape, or an elliptical shape, unnecessary diffraction at the corners of the non-diffracting region can be prevented.

### Additional Remark 7

The virtual image display apparatus according to any one of Additional Remarks 3 to 6, wherein

the polarizing region includes, sequentially from a side facing the display unit, a polarizing plate configured to restrict the video light to transmit only predetermined linearly polarized light, and a quarter-wave plate configured to convert the predetermined linearly polarized light into predetermined circularly polarized light.

The video light output from the display unit can thus be changed to circularly polarized light.

### Additional Remark 8

The virtual image display apparatus according to any one of Additional Remarks 3 to 7, wherein

the display member is an image display panel having as the display region a light emitting region where the video light is formed.

### Additional Remark 9

The virtual image display apparatus according to any one of Additional Remarks 3 to 7, wherein

the display member includes a backlight and a liquid crystal panel, and

the liquid crystal panel has video light generating pixels as the display region and outside light transmitting pixels as the first outside light transmitting region.

### Additional Remark 10

An optical unit including:

a display unit configured to output circularly polarized video light and transmit outside light; and

a polarizing diffractive lens having a diffracting region configured to collect the video light output from the display unit and a non-diffracting region configured to transmit the outside light passing through the display unit.

What is claimed is:

1. A virtual image display apparatus comprising:
a display unit configured to output circularly polarized video light and transmit outside light; and
a polarizing diffractive lens having a diffracting region configured to collect the video light output from the display unit and a non-diffracting region configured to transmit the outside light passing through the display unit.

2. The virtual image display apparatus according to claim 1, wherein
in the polarizing diffractive lens, the non-diffracting region is configured with multiple non-diffracting regions arranged in the form of islands, and a remaining region serves as the diffracting region in a plan view.

3. The virtual image display apparatus according to claim 1, wherein
the display unit includes a display member and a polarizing element as a light separating member configured to separate the video light and the outside light,
the display member has a display region via which the video light is output and a first outside light transmitting region through which the outside light passes, and
the polarizing element has a polarizing region where the video light output from the display region is converted into circularly polarized light and a second outside light transmitting region through which the outside light passes.

4. The virtual image display apparatus according to claim 3, wherein
the display region is configured with multiple display regions and the first outside light transmitting region is configured with multiple first outside light transmitting regions, the multiple display regions and first outside light transmitting regions being disposed in the display member, and
in the polarizing element, the polarizing region is configured with multiple polarizing regions disposed at positions corresponding to the display regions, and the second outside light transmitting region is configured with multiple second outside light transmitting regions disposed at positions corresponding to the first outside light transmitting regions.

5. The virtual image display apparatus according to claim 3, wherein
the non-diffracting region is larger than the second outside light transmitting region.

6. The virtual image display apparatus according to claim 1, wherein
the non-diffracting region has any one of a quadrangular shape, a quadrangular shape with rounded corners, a circular shape, and an elliptical shape.

7. The virtual image display apparatus according to claim 3, wherein
the polarizing region includes, sequentially from a side facing the display unit, a polarizing plate configured to restrict the video light to transmit only predetermined linearly polarized light, and a quarter-wave plate configured to convert the predetermined linearly polarized light into predetermined circularly polarized light.

8. The virtual image display apparatus according to claim 3, wherein
the display member is an image display panel having as the display region a light emitting region where the video light is formed.

9. The virtual image display apparatus according to claim 3, wherein
the display member includes a backlight and a liquid crystal panel, and
the liquid crystal panel has video light generating pixels as the display region and outside light transmitting pixels as the first outside light transmitting region.

10. An optical unit comprising:
a display unit configured to output circularly polarized video light and transmit outside light; and
a polarizing diffractive lens having a diffracting region configured to collect the video light output from the display unit and a non-diffracting region configured to transmit the outside light passing through the display unit.
